(19) United States
(12) Patent Application Publication
(10) Pub. No.: US 2012/0221211 A1
(43) Pub. Date: Aug. 30, 2012

(54) METHOD AND CONTROL UNIT FOR DETECTING THE WIDTH OF AN IMPACT AREA OF AN OBJECT IN THE FRONT-END SECTION OF A VEHICLE

(76) Inventors: Thomas Lich, Schwaikheim (DE); Gian Antonio D'Addetta, Stuttgart (DE)

(21) Appl. No.: 13/393,985

(22) PCT Filed: Nov. 22, 2010
(86) PCT No.: PCT/EP10/67903

§ 371 Date: May 15, 2012

(30) Foreign Application Priority Data
Nov. 24, 2009 (DE) 102009047071.9

(51) Int. Cl. B60R 21/0136; G06F 7/00

(52) U.S. Cl. 701/46; 701/1

(57) ABSTRACT

A method is described for detecting a width of an impact area of an object in the front-end section of a vehicle, which has a step of receiving a first deformation element signal, which represents a change in the distance of components of a first deformation element from one another, that is mounted in the left front-end section of the vehicle. Furthermore, the method includes a step of receiving a second deformation element signal, which represents a change in the distance of components of a second deformation element from one another, that is mounted in the right front-end section of the vehicle. Finally, the method includes detection step of an offset collision with a small width of an impact area of the object on the vehicle, if the first deformation element signal differs by more than a predefined threshold value level from the second deformation element signal.

### BACKGROUND INFORMATION

Since the introduction of the passenger cell in motor vehicles, vehicle safety has clearly developed further. The number of people killed in road traffic has been able to be clearly reduced by using components of active and passive safety. In a majority of accidents, vehicle to vehicle front-end collisions are involved having a high degree of injury, up to a fatal result. Because of the introduction of user protection tests, as well as legal requirements with respect to front-end collisions with 100% and 40% overlapping, respectively, substantial improvements have been achieved, up to now, with respect to reducing accident consequences. Because of that, however, other types and topics of collision have come to the fore in recent times. One of these newer topics may be seen in reinforced partner protection and better crash compatibility.

Basically, self-protection is in the forefront, within the development process of the passive safety of a vehicle. This is the characteristic of a vehicle of protecting its own passengers both in vehicle-to-vehicle collisions and in collisions with other objects. By contrast, there is partner protection, which is the characteristic of the vehicle to protect the passengers of the opposing vehicle, in a vehicle-to-vehicle collision, that is, to have as low an aggressiveness as possible. The two characteristics are combined in the term crash compatibility. This combination denotes a high degree of self-protection at low aggressiveness with respect to other traffic participants, in such a way that the overall risk in the vehicle fleet is minimized. There is general agreement that improvement in compatibility must not be at the expense of the self-protection of individual vehicles.

Accident data will show that, it is true, that crash tests existing today have vastly improved self-protection, but that this is accompanied by a simultaneous reduction in partner protection. With this in view, in the future there may be new user protection tests for the front-droop case, in order to be able to evaluate better the compatibility characteristics of vehicles. In order to obtain greater compatibility of the vehicle in practice, interventions may be made in future in the vehicle's front-end structure and the vehicle's rear-end structure. To do this, some approaches already exist.

German Patent Application No. DE 10 2004 036 836 Al describes a deformation element for vehicles having a first force absorption unit, at least one second force absorption unit, that is able to absorb an affecting force that is above a specified force value, and a sensor for the detection of a force acting upon the deformation element. With that, the deformation element has an absorption response that is adapted to the collision object, especially a pedestrian, and lowers the risk of injury for pedestrians.

### SUMMARY

In accordance with the present invention, an example method, an example control unit using this method, and a corresponding example computer program product is provided.

In accordance with the present invention, an example method is provided for detecting the width of an impact area of an object in the front-end section of a vehicle, the method having the following steps:
receiving a first deformation element signal which represents a change in the distance of components, of a first deformation element, from one another, that is mounted in the left front-end section of the vehicle;
receiving a second deformation element signal which represents a change in the distance of components, of a second deformation element, from one another, that is mounted in the right front-end section of the vehicle;
detecting an offset collision, with a small width of an impact area of the object, on the vehicle if the first deformation element signal differs by more than a predefined threshold value level from the second deformation element signal.

By deformation element, one would understand, in this context, an energy-absorption element which is deformed irreversibly or reversibly in response to the impact of an object on the vehicle. Energy is absorbed by the deformation, and the impact of the object on the vehicle (or reversely, of the vehicle on the object) is softened. The deformation element may be made of a folded sheet metal construction, which bends, upon impact of another vehicle or a tree as object, and thereby absorbs a certain portion of the impact energy. The present invention also addresses reversible or adaptively actuatable deformation elements. These are already being explored, and offer the advantage of having a sensor system already installed for controlling the deformation elements according to the classified situation. Injuries that can possibly occur to a vehicle passenger or a pedestrian during an accident are able to be minimized thereby. The term offset collision is understood to mean, in this case, a collision between the object and the vehicle, in which the area of impact of the object on the vehicle does not extend completely over the entire vehicle front end. Rather, in such an offset collision, only a partial area of the front end of the vehicle is hit by the oncoming object.

The present invention further provides an example control unit which is developed to carry out or implement the steps of the example method according to the present invention. By this embodiment variant of the present invention, in the form of a control unit, the object on which the present invention is based can also be attained quickly and efficiently.

In the case at hand, a control device is an electrical device which processes sensor signals and outputs control signals as a function thereof. The control unit may have an interface, which may be implementable as hardware and/or software. In a hardware design, the interfaces may, for example, be part of a so-called system ASIC, which contains various functions of the control unit. However, it is also possible for the interfaces to be separate, integrated circuits or to be at least partially made up of discrete components. In a software design the interfaces may be software modules which are present on a microcontroller in addition to other software modules, for example.

An advantageous development also includes a computer program product having program code that is stored on a machine-readable medium such as a semiconductor memory, a hard-disk memory or an optical memory, which is used to implement the example method according to one of the specific embodiments described above, when the program is executed on a control unit.

In accordance with the present invention, deformation elements already present and sensor units on these deformation elements may further be used very simply for an additional benefit. In this context, a signal from a sensor on a deformation element is linked on the right side of the vehicle, in the direction of travel, to a signal that was provided by a sensor on a deformation element on the left side of the vehicle, in the direction of travel. The signal from the first deformation element on the right side of the vehicle may represent a distance change of two components of this first deformation element, for example, or even a speed at which these two components of the first deformation element are moving towards each other, or additional variables derived from this, such as the acceleration. Analogously, the signal from the second deformation element on the left side of the vehicle may also represent a distance change of two components of this second deformation element, for example, or even a speed at which these two components of the second deformation element are moving towards each other, or additional variables derived from this, such as the acceleration. Now, if an object, such as an oncoming vehicle, hits the host vehicle only in a small overlapping area of the front end, an uneven stress of the two deformation elements will take place. The deformation element that is located on the side of the vehicle that is greatly affected by the impact of the oncoming object, will clearly be more greatly deformed than the deformation element that is located on the side of the vehicle that is affected less, or not at all, by the impact of the oncoming object. For this reason, the determination of an offset collision may be achieved very simply using a small (maximum) width of an impact area of an object on the front-end section of the vehicle, by an evaluation of the corresponding signals from the first and the second deformation element. This may be done, for example, by detecting that the value of the first deformation element signal differs by more than a predefined threshold value from the value of the second deformation element signal. The first deformation element signal may also be linked to the second deformation element signal by a difference formation, for example, to obtain a linkage signal and subsequently to check an absolute value of the linkage signal for exceeding or falling below a threshold value.

By making a comparison of the two deformation element signals, or a linkage of these two signals, and a subsequent comparison of the linkage results to a threshold value, one may recognize, to wit, that the deformation of one of the two deformation elements is substantially greater than the deformation of the other of the two deformation elements. From this, one may conclude that the oncoming object has not first impacted the host vehicle over the full width of the front end, and is penetrating into the vehicle structure, but has first impacted only a subrange of the host vehicle front end, namely the subrange of the vehicle front end in which the deformation element, having suffered the greater deformation, is situated. By the selection of a suitable comparison threshold value, it may then be detected, by recourse to experience values in a laboratory, how great the overlap is of the areas of impact between the front end of the vehicle of the host vehicle and the front end of the oncoming vehicle. If the overlap of the impact areas of the oncoming object and the front end of the vehicle is greater, the deformations suffered of the two deformation elements approach each other, so that one may expect similar or almost equal signal values with respect to the distance change of components of the two deformation elements. In this case, a linkage of the first deformation element signal to the second deformation element signal will no longer yield a linkage signal that has an absolute value that lies above the predetermined threshold value.

The present invention has the advantage that signals of already available and installed components may be utilized in a simple manner, in order to make possible an additional benefit for vehicle safety. If it is detected, for instance, that an object impacting the vehicle strikes the front end of the vehicle only in a smaller overlapping area, one may assume that the vehicle will rotate after the collision. In this case, other passenger protective devices should be activated than would be required in response to a frontal impact, having a very large overlapping area between the oncoming object and the front end of the vehicle.

In one favorable specific embodiment of the present invention, furthermore, a step is provided of linking the first deformation element signal to the second deformation element signal, so as to obtain a linkage signal, a step being recognized of detecting a smaller width as maximum width of an impact area of the object on the vehicle, if an absolute signal level value of the linkage signal has a value that exceeds a predetermined threshold value. Such a specific embodiment of the present invention has the advantage of a technically very simply implemented evaluation possibility for the first and the second deformation element signal, a comparison using different threshold value levels being possible, which represent different overlapping areas.

In one suitable specific embodiment of the present invention, in the linkage step a formation is carried out of a difference, an addition, a multiplication and/or a division among values of the first and second deformation element signal. Such specific embodiments of the present invention have the advantage of a possibility that is technically very simple and quick to implement for determining the linkage signal. Consequently, one may do without providing additional computing units or a larger and more efficient computing unit for implementing the present invention. Even already preprocessed values of the, first and second deformation element signal, as are usually, and for example, carried out in the case of filter stages, may be used for evaluation.

Also, in the detection step, an average width of an impact area of the object on the vehicle may be detected, if an absolute value of the linkage signal has a value that is below the predetermined threshold value, but above a predetermined second threshold value. Such a specific embodiment of the present invention offers the possibility, by using differently graded threshold values, of determining different degrees of overlapping between a width of the oncoming object and a frontal width of the host vehicle.

It is also favorable if, in the detection step, a large width of an impact area of the object on the vehicle is detected if the linkage signal has a signal level value that is within a tolerance range about a value of zero. Such a specific embodiment of the present invention has the advantage that a frontal impact of an object on the vehicle also becomes detectable, the object impacting the host vehicle nearly over the entire width of the vehicle. In this case, it is possible to undertake a different activation of various personal protection devices for passengers of the vehicle, depending on which overlapping width of the impact object with the front end of the vehicle was detected. In this context, the tolerance range to be taken into account may have ca. 15% of the value range that is available in an evaluation unit for the evaluation of the first or the second deformation element signal.

Moreover, in the detection step, a rear-end impact of an object on the vehicle may also be recognized if an additional signal, which represents a positive acceleration in the travel direction of the vehicle, is received together with a linkage signal whose signal level value lies within a tolerance range about the value zero. Such a specific embodiment of the present invention has the advantage that the present invention may further be used for a plausibility check of a rear-end impact. For, in a rear-end impact of an object on the vehicle, no deformation of the frontal area is detected, so that also no deformation of the first and/or second deformation element is to be expected. Nevertheless, because of the push from behind, a detectable acceleration is exerted on the vehicle, so that the combination of this positive acceleration (for instance, in the form of an AND operation) with a signal level value of the linkage signal, which corresponds to a value of zero within a tolerance range, permits drawing the conclusion that such a rear-end collision has taken place. In this context, the tolerance range to be taken into account may have ca. 15% of the value range that is available in an evaluation unit for the evaluation of the first or the second deformation element signal. In addition, in a further supplementary or alternative embodiment, a second tolerance may be taken into account. This is a temporal variable that is taken into account. This may be implemented via a counter unit, for example, which is compared in an additional linking stage (for instance in the form of an AND operation). This may become necessary since, in traffic jam situations, for example, additional bumper-to-bumper collisions may occur. In these types of collision, first a primary collision takes place in the rear-end section and then an additional secondary collision at the front end. Based on the distance from the vehicle in front, however, a temporal limitation should be taken into account before the impact takes place, which is in the range of less than 0.5 s.

In order to achieve an additional increase in personal safety for vehicle passengers, the example method, responsive to an evaluated linkage signal, may also have a step of outputting a control signal for a vehicle passenger protection unit of the vehicle.

According to a further specific embodiment of the present invention, in the detection step, a predetermined degree of severity of an impact of the object on the vehicle is also detected if a signal amplitude of the first and/or the second deformation element signal changes within a predefined evaluation time by more than a predetermined difference in amplitude. Such a specific embodiment of the present invention may have the advantage of an additional evaluation of a received first deformation element signal or an obtained second deformation element signal. In this connection, the signal already received may be evaluated according to additional evaluation criteria, so that an additional benefit may be drawn upon from signals that are already available by using additional signal processing that is technically easy to implement.

According to one additional specific embodiment of the present invention, in the detection step, the penetration depth of the object may also be detected, responsive to a signal amplitude of the first and/or the second deformation element signal. Such a specific embodiment of the present invention also has the advantage of an additional evaluation of an already available first and/or second deformation element signal, so that from this signal, an additional benefit may be drawn upon, by further signal processing that is technically easy to implement, while using an additional evaluation criterion.

In still another specific embodiment of the present invention, in the detection step, an impact of the object in the area of the left front-end section of the vehicle is able to be detected, if from the first and second deformation element signal a greater deformation of the first deformation element compared to the second deformation element is detected, and/or that in the detection step an impact of the object in the area of the right front-end section of the vehicle is detected, if from the first and second deformation element signal a greater deformation is to be detected of the second deformation element compared to the first deformation element. Such a specific embodiment of the present invention offers the advantage that a detection of the side of the impact of the object upon the vehicle in the front-end section is recognized that will probably result in the rotation of the vehicle. This makes it possible, depending on the vehicle rotation to be expected after the impact, to be able to activate appropriately different personal safety means in good time. A greater deformation of one of the two deformation elements as opposed to the other deformation element may be detected, in this context, for example, from a greater change in the distance apart of two components of the more greatly deformed deformation element compared to a change in the distance apart of two components of the lesser deformed deformation element.

### BRIEF DESCRIPTION OF THE DRAWINGS

The present invention is explained in greater detail by way of example, with reference to the figures.

FIG. 1 shows a block diagram of a first exemplary embodiment of the present invention.

FIG. 2 shows a representation of an exemplary embodiment of the installation of deformation elements in a front-end section of the vehicle.

FIGS. 3a-b show a representation of a crash-adaptive carrier element having measurement of the distance apart of components of the deformation element.

FIG. 4 shows a schematic representation of an offset collision having an appertaining diagram in which the signals of the sensors from the first and second deformation element are shown.

FIG. 5 shows a schematic representation of a full frontal collision having an appertaining diagram in which the signals of the sensors from the first and second deformation element are shown.

FIG. 6 shows a block diagram of a first simple algorithm for offset collision detection.

FIG. 7 shows a schematic representation of a rear-end collision having an appertaining diagram in which the signals of the sensors from the first and second deformation element are shown.

FIG. 8 shows a block diagram of a simple algorithm for detecting a rear-end collision.

FIG. 9 shows a flow chart of an exemplary embodiment of the present invention as a method.

### DETAILED DESCRIPTION OF EXAMPLE EMBODIMENTS

In the figures, same or similar elements may be shown by same or similar reference numerals, a repeated description of these elements being omitted. Furthermore, the figures and their description contain numerous features in combination. In this context, it is clear to one skilled in the art that these features may also be considered individually or may be combined to form further combinations not explicitly described here. Furthermore, the present invention will perhaps be explained in the following description using different measures and dimensions, while the present invention should be understood as not being restricted to these measures and dimensions. Furthermore, example method steps according to the present invention may also be carried out repeatedly, as well as in a different sequence than the one described. If the exemplary embodiment includes an “and/or” linkage between a first feature/step and a second feature/step, this may be read to mean that the exemplary embodiment, according to one specific embodiment has both the first feature/the first step and also the second feature/the second step, and according to an additional specific embodiment, either has only the first feature/step or only the second feature/step.

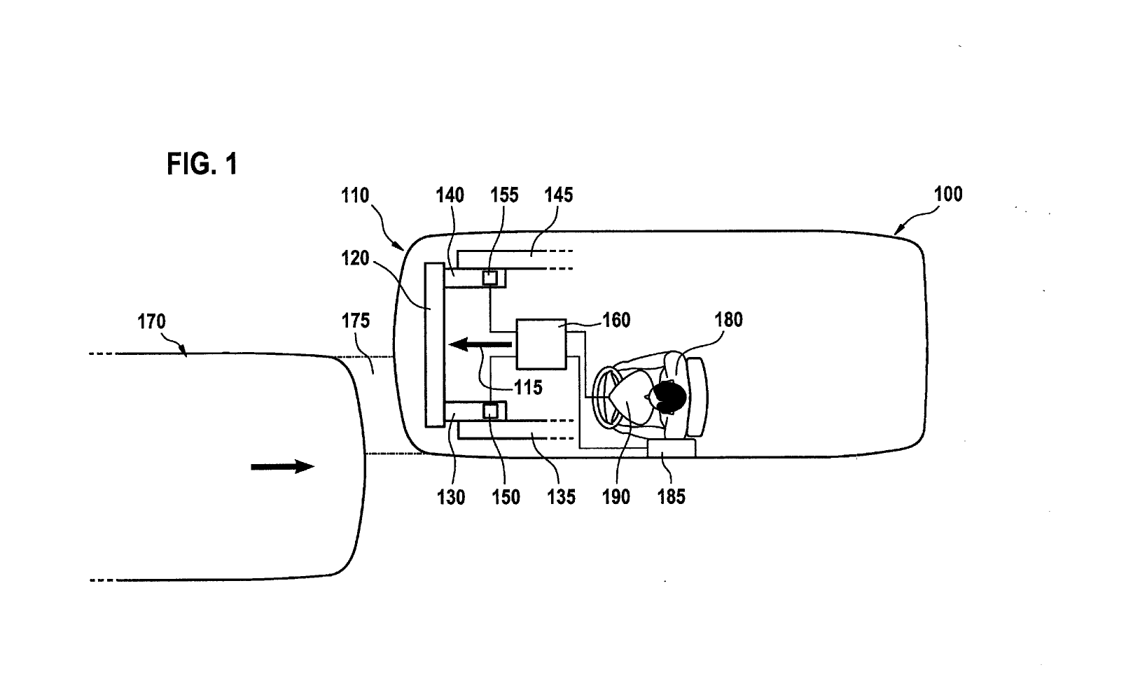

FIG. 1 shows a block diagram of a first exemplary embodiment of the present invention. A vehicle 100 is shown in FIG. 1, in this context, which has a cross member 120 in front-end section 110, as seen in travel direction 115. Cross member 120 is connected via a first deformation element 130 to a left frame longitudinal member 135 of vehicle 100. Moreover, cross member 120 is connected via a second deformation element 140 to a right frame longitudinal member 145. First deformation element 130 includes a sensor or a sensor system 150, in this context, which is developed to measure a distance apart or a change in the distance apart between at least two components of first deformation element 130. Second deformation element 140 also includes a sensor 155 which is developed to measure a distance apart or a change in the distance apart of at least two components of the deformation element 140. In this context, first sensor/sensor system 150 is able to transmit a corresponding first sensor or deformation element signal to an evaluation unit 160, and second sensor/sensor system 155 is able to transmit a corresponding second sensor or deformation element signal to an evaluation unit 160.

Now, if an impact of an object takes place, such as vehicle 170, shown in FIG. 1, on front-end section 110 of vehicle 100, a deformation of vehicle 100 will take place, which has the effect of pressing in cross member 120 in the direction towards the interior of the vehicle. However, since oncoming vehicle 170 meets front-end section 110 of vehicle 100 in an overlapping area 175, when the impact occurs, a different deformation response of the components of vehicle 100 will also result. In this case, an offset collision is recognized, which may also be designated as an axis offset collision. In this context, in particular, first deformation element 130 on the left side of the vehicle is more greatly deformed than second deformation element 140 on the right side of the vehicle. The result is that first sensor 150 will register a greater change in the distance apart of components of first deformation element 130 than a change in the distance apart of components of second deformation element 140 that will be registered by second sensor 155. Starting from the first deformation element signal of first sensor 150 and from the second deformation element signal of second sensor 155, evaluation unit 160 is therefore able to record such a different change in distance apart of components of first deformation element 130 as opposed to a change in distance apart of components of second deformation element 140. This may be done, for instance, by forming a difference between a value of the first deformation element signal and a value of the second deformation element signal, this difference then being compared with a predefined threshold value. If it is determined in the process that the difference (or, putting it more exactly, an absolute value of the difference) is greater than the predefined threshold value, that is, that a change in the distance apart of components of first deformation element 130 is greater than a change in the distance apart of components of second deformation element 140, it may be concluded by using evaluation unit 160 that oncoming vehicle 170 hits vehicle 100 only in an overlapping area 175, which is smaller than the overall width of vehicle front-end section 110.

A plurality of threshold values may also be used, in this context, which in each case represent differently sized overlapping areas 175 with reference to entire vehicle front-end section 110. By contrast, if oncoming vehicle 170 strikes the entire width of front-end section 110 of vehicle 100, one would expect an approximately equal deformation response of first deformation element 130 and second deformation element 140. In this context, we assume that first deformation element 130 and second deformation element 140 have an equal deformation response.

Now, if an impact of object 170 is detected by evaluation unit 160 on the left part of front-end section 110, one may conclude from this, for example, that a rotation of the vehicle will take place directly thereafter. In such a case, evaluation unit 160 is now able to activate a personal safety device for a passenger 180 of the vehicle, such as one that will especially effect a personal protection in response to such lateral rotation. A side air bag 185 may be activated by evaluation unit 160, for example, to hold passenger 180 in a predetermined position on a vehicle seat. If, on the other hand, an overlapping area 175 is detected in evaluation unit 160, which corresponds generally to entire vehicle front end 110, one should assume a frontal impact of object 170 having high overlapping coverage, so that no vehicle rotation, or only a slight one is to be expected. In this case, a front air bag 190 could be activated by evaluation unit 160, which deploys as great as possible a protective action in response to a frontal impact without lateral rotation of vehicle 100.

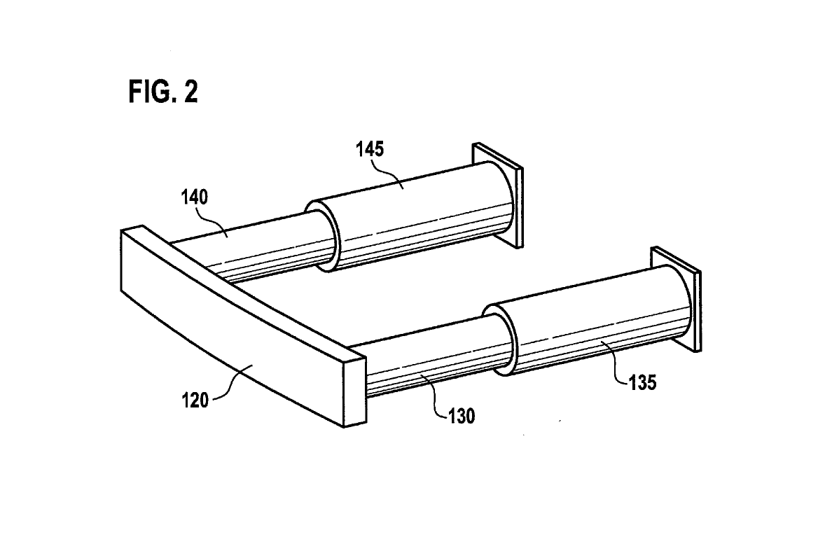

In order to use the present invention as well as possible, one may use an adaptive front-end structure, as is shown in FIG. 2. FIG. 2 shows a schematic view, in which deformation elements 130 and/or 140 are developed as adaptive crash elements, which are situated between frame longitudinal members 135 and 145 (which are in this case developed fixed to the body) and a cross member 120. The two adaptive crash elements 130 and 140 are able to be adapted in their rigidity and their deformation response, and are coupled by a wide cross member and, for example, provided with a foam element.

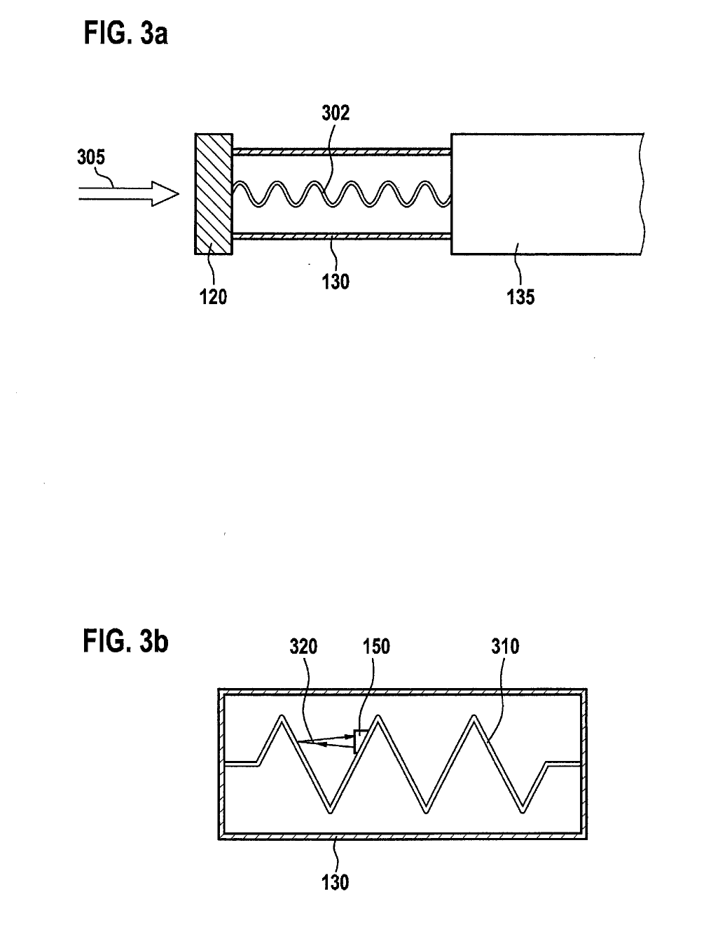

It is the aim of adaptive front-end structure systems or adaptive crash boxes, among other things, to carry out an adaptation of the front-end structure, even during the collision and furthermore with the aid of a sensor system that looks ahead and is integrated into the system. A basic principle of the installation of a measuring system, that is able to be used in this instance, is shown schematically in FIG. 3a. An adaptive deformation element 130 is used between cross member 120 and a frame longitudinal member (such as frame longitudinal member 135). In this context, the deformation element includes a measuring system 302 which, responsive to a deformation, a speed or an acceleration of components of deformation element 130, outputs a corresponding signal. Measuring system 302 may have a folding structure on the inside of the deformation element, via which, when a crash occurs, for example, from direction 305, a change of length of deformation element 130 is recorded in total. An example of such a sensor system looking ahead and having such a measuring system is shown schematically in greater detail for deformation element 130 in the area of the left front end of the vehicle in FIG. 3b. The deformation element, including the associated sensor, which is installed on the right side of the vehicle, is constructed analogously to the illustration in FIG. 3b, for example. Now, the adaptation of the rigidity is based on the control/regulation of just this carrier system or rather this adaptive crash box. For this, an example system is provided, for example, in which, according to the illustration in FIG. 3b, a radar element 150, or alternatively also an expansion measuring element is integrated, as a sensor of the change in the distance apart, into the structure of the deformation element, and consequently measures the current distance apart or the current length of the relevant components of deformation element 130 (such as a reflection surface of a folding sheet metal 310 deformed in response to the impact). A radar beam 320 of sensor 150 is radiated in the travel direction of the vehicle, which is reflected by a reflector area of folded sheet metal 320. Alternatively, a change in the distance apart of the individual surfaces of folded sheet metal 320 by a change in resistance may also take place if, for instance, an expansion measuring strip is used as sensor 150. If the deformation element is deformed by the impact of object 170 coming from the impact direction, the distance of two components changes, and a measuring signal is output by sensor 150 that corresponds to the change in the distance. In the selection of adaptable deformation elements, depending on the situation, the deformation element may be set in such a way that a higher or lower rigidity is to be registered. In this way, one may also implement an adaptive deformation element structure.

The triggering of personal safety devices of today's passive systems is based, as a rule, on acceleration signals or structure-borne noise signals in a central air bag control unit. In addition, peripheral sensors, so-called upfront sensors (UFS) are also used, which are intended to enable early crash detection. Over and above that, there already exist a few attempts and ideas also to use the sensors used in the pedestrian protective area as additional input signals for front-end collision detection. In spite of the use of, meanwhile, a substantial number of sensors, there still exists the challenge of separating a full frontal crash against a rigid barrier (i.e. an impact of an object that impacts the vehicle over the entire vehicle front-end width) from an insurance test AZT by signal technology. Now, one aspect of the present invention is that the sensors installed in an adaptive front-end structure, which are used for deformation detection that is intrinsic to the system and/or for distance measurement, are able to be used, besides for their actual task of regulating the adaptive front-end structures, also for offset detection and crash detection, and are provided as an additional input signal for the central air bag control unit. Furthermore, with the aid of the approach introduced here, and with the aid of the already installed sensors, a “low overlap” detection recognition may be performed, that is, a recognition as to whether an object is impacting the vehicle only in a small lateral subrange of the front end of the vehicle. Since in the “low overlap” case, that is, a frontal collision having an overlap of less than 15%, for example, of the front-end width of the vehicle, on the left, next to left frame longitudinal member structure 135, or on the right, next to right frame longitudinal member 145, no significant intrusions occur in the front-end structure of the vehicle, and, going along with that, there occurs hardly any reduction in speed, this load case is also indirectly reflected in the signals in the form of lacking amplitudes on non-loaded sensors. Thus a “low-overlap” case, of a standard offset case, of an impact of an object having 40% overlap, with reference to the front-end width of the vehicle, is able to be separated from the case of a frontal collision having 100% overlap with reference to the front-end width of the vehicle.

Over and above that, with the approach introduced here, the possibility exists of carrying out a rear-end crash plausibility check with the aid of these integrated sensors 150 and 155, since, as a rule, in the case of a rear-end collision, no signal is received within the 50 ms for triggering, and in such a case, will measure no inner deformation of deformation elements 130 or 140. In addition to the possibilities already named, there also exists the possibility of providing crash severity information to the central air bag control unit. This may be ascertained via deformation internal to the system and associated deformation speed, and a corresponding sample comparison.

In summary, one may say that the approach presented here has some advantages, which are made possible using the above sensor system integrated into the system:

In the first place, detection and classification of an offset collision, as opposed to a frontal collision having 100% overlap, is able to be achieved. The detection is based on the comparison of the signals on the left and the right channel of the frame longitudinal member, (i.e. a signal that originates with a deformation element sensor of the deformation element on the left front-end structure, as opposed to a signal that originates with a deformation element sensor of the deformation element on the right front-end structure). In this context, a mathematical or logical linkage of the two signals is carried out, for example, and the result of the linking is evaluated. Secondly, a detection and separation of a low-overlap collision, which is distinguished by a lacking intrusion of the frame longitudinal member, may be separated from a collision in which the frame longitudinal members are intruded. The detection of such a collision is based on the lacking intrusion of the frame longitudinal members and the lower signal amplitude and the other type of behavior of the signals in comparison to a frontal collision having intrusion. In the third place, a rear-end collision plausibility check may take place by a lacking signal in the front-end section, whereby an additional use becomes possible of signals of sensors that are already installed. In fourth place, the approach proposed here makes possible the determination of a crash severity measure in the light of the system intrusion, that is, in the light of the deformation of the structure of the deformation elements and the associated deformation speed v of the structure of the deformation elements.

A first aspect of the present invention may be seen in that the system-integrated sensors, used primarily for an adaptive structure, for controlling/regulating of the actuator system may also be used as sensors of the passive restraint system, to the extent that, among other things, the previously named advantages may be made possible. Moreover, the sensor system may be used in combination with other sensors, such as the central acceleration sensor, as an additional input variable in triggering passive restraint systems.

According to an additional aspect of the present invention, the use of the sensor system already installed aims primarily at the following areas:

First of all, the providing of data is able to take place, for instance, signals are put on the CAN bus or provided directly to a central control unit, such as the air bag control unit. Furthermore, a special evaluation of the information may be made in the control unit, and subsequently, the evaluated signal may be provided to other control units, such as a passenger protective device control unit, using a bus signal. In third place, a special evaluation of the information located in the control unit and a special control of other means of restraint, such as the front-end air bag and/or the side air bag and/or curtain air bag may take place at low-overlap crash cases, whereby the passenger safety is clearly able to be increased. In fourth place, peripheral sensor signals, that are already present, such as the signals of the abovementioned deformation element sensors, may be used as input signals for a control unit for controlling active and/or passive restraint components.

Of particular advantage is the approach now proposed, since thereby many advantages are able to be implemented simultaneously. First of all, a cost reduction may be achieved by saving upfront or peripheral sensors for the offset detection. Conditioned on that, one is able to achieve an additional cost reduction by saving the integration of the acceleration signals in the control unit, and thus saving corresponding software and resources. In addition, an increase in the detection robustness of the air bag triggering algorithm may be achieved by reliable evidence on intrusion depth, intrusion speed and corresponding reduction in sensitivity. At the same time, a reliable detection of a “low-overlap” collision may be implemented, and there is furthermore a saving potential of an “-x” sensor for a rear-end crash plausibility check, and thereby multiple utilization of the sensor system of the already installed adaptive structure in the vehicle's front-end section. Furthermore, it is also possible to obtain additional information for the crash type and crash severity classification, and thus to obtain an improved triggering performance and to make possible a more unequivocal classification of “low-overlap” collisions in comparison to making possible classification based on acceleration signals. In addition, a clearer safety gain for the passenger may be achieved, by adaptive and time-coordinated control possibilities of passive safety systems, during “low-overlap” cases, offset cases and full frontal loading cases. Thus, the approach proposed here may be regarded as a basic principle, since, in the future, the sensors already present in the vehicle represent multiple utilizations for the passive safety systems.

The present invention provides that an evaluation of the sensor signals takes place in a separate or an already existing control unit, for instance, the air bag control unit. In the case of an evaluation in a central triggering control unit, the information is transmitted to a bus system either as a raw signal and/or in prepared and/or preprocessed information. In the case of an evaluation in a special control unit, the information may also be provided to other control units, using a bus communication. It is also possible to combine this information with other signals, for instance, from the driving dynamics regulating system and/or an acceleration sensor in such a way that additional control and/or regulating signals are obtainable, so that the control of reversible and/or irreversible systems is able to take place, for example. It is also possible to record the signals in a recorder provided especially for this, so that after a collision, this information is able to be called up again. Over and above that, it is also possible to collect and call up the information for a setting or calibration of an algorithm in a databank, so that a suitable setting of the control unit takes place.

In a first favorable embodiment of the present invention, a signal from the left actuator and a signal from the right actuator are linked to each other, so that a query via a threshold value gives a statement on the offset collision. It is clear that a linkage of the information by subtraction/addition/multiplication or other mathematical functions is also to be considered.

In the implementation shown here in exemplary fashion, the subtraction of the right channel from the left channel is carried out.

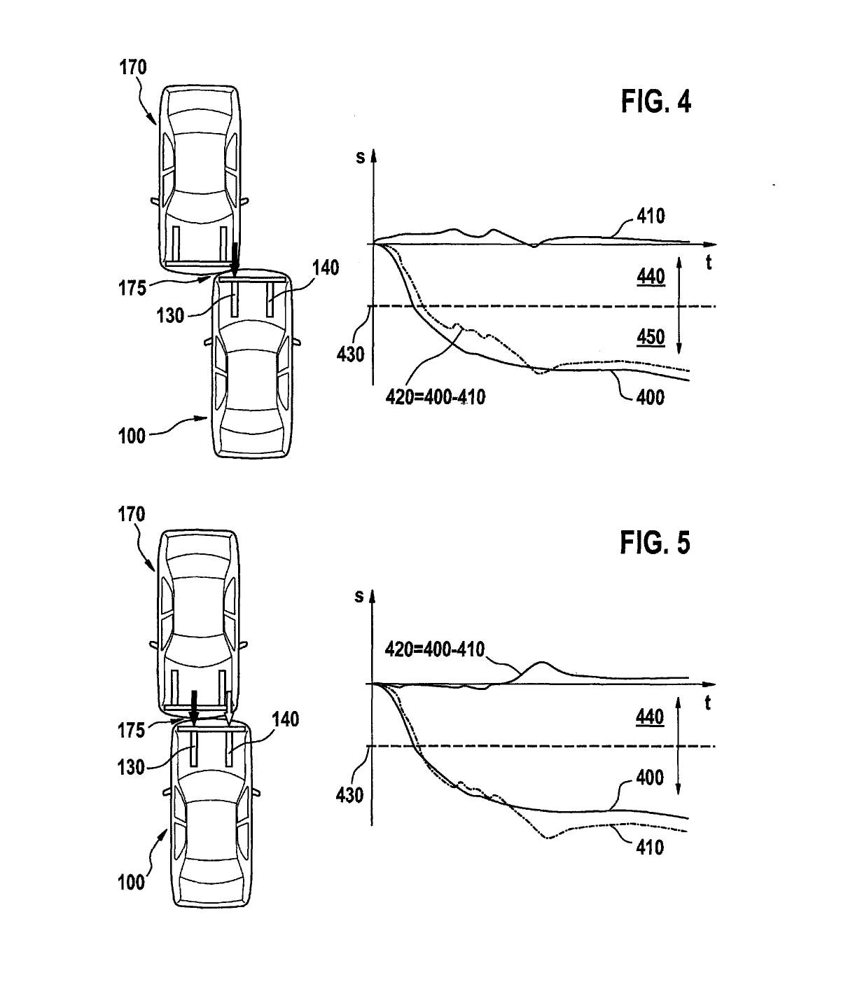

FIG. 4 shows an offset collision between two vehicles. Target vehicle 100 at the bottom of FIG. 4, in this instance, is equipped, in this context, with an adaptive frontal structure, as it was described above. The measurement of the signals takes place, for instance, via a radar sensor, as was mentioned above. It is installed in the system and measures the path of the structure of the respective deformation element at which the radar sensor is situated.

The left structure of vehicle 100 is hit and intruded, in this context, whereas the right structure of the vehicle is not intruded or only contingently so. In the case of a collision, there will thus be an intrusion on the left adaptive crash structure. It will deform, and with that, its length becomes shorter. The sensor measures precisely this path. For instance, say, the path becomes shorter, which is characterized for the corresponding signal of this sensor 150 for the left deformation element in the time(t)-intrusion diagram in FIG. 4 by reference numeral 400, and a negative sign. By contrast to this, the signal from the sensor of right deformation element 140 (designated by reference numeral 410 in the diagram in FIG. 4) remains nearly constant. Presumably, based on the deformation, a lesser change in the structure is expected. Now, if the difference 420 is formed, of values of the two signals 400 and 410, the result is the signal characterized by reference numeral 420. Using a threshold value 430, in a preferred, exemplary embodiment, a separation of detection is able to be made between an offset collision and a full frontal collision. In this context, a (full) frontal collision 440 is assumed if the difference signal value is in a range between a value of zero and the threshold value 430, whereas an offset collision 450 is able to be recognized if the difference signal value 420 is in a range of less than threshold value 430. Were an exchange of signals 410 and 420 made for the difference formation, an evaluation would have to be made in such a way that the offset collision would be detected if the difference signal is greater than a threshold value. It may therefore be said in general that an offset collision is recognized if an absolute value of the difference signal is greater than a threshold value. However, different degrees of overlapping may also be recognized, using the approach described herein. For this purpose, one would then only make an evaluation using different threshold values, so that in this case each threshold value represents its own degree of overlapping.

A full frontal collision (that is, a 100% overlapped collision) is shown, for example, in FIG. 5. In this instance, a left and a right deformation element structure of the vehicle is impacted and intruded. Thus, the two vehicles 100 and 170 meet at close to 100% overlapping. Both frontal structures 130 and 140 are deformed in this instance. This deformation may be pronounced to a different extent in the left and right adaptive structures 130 and 140, to be sure, but difference signal 420 (especially seen as an absolute value) remains below threshold value 430.

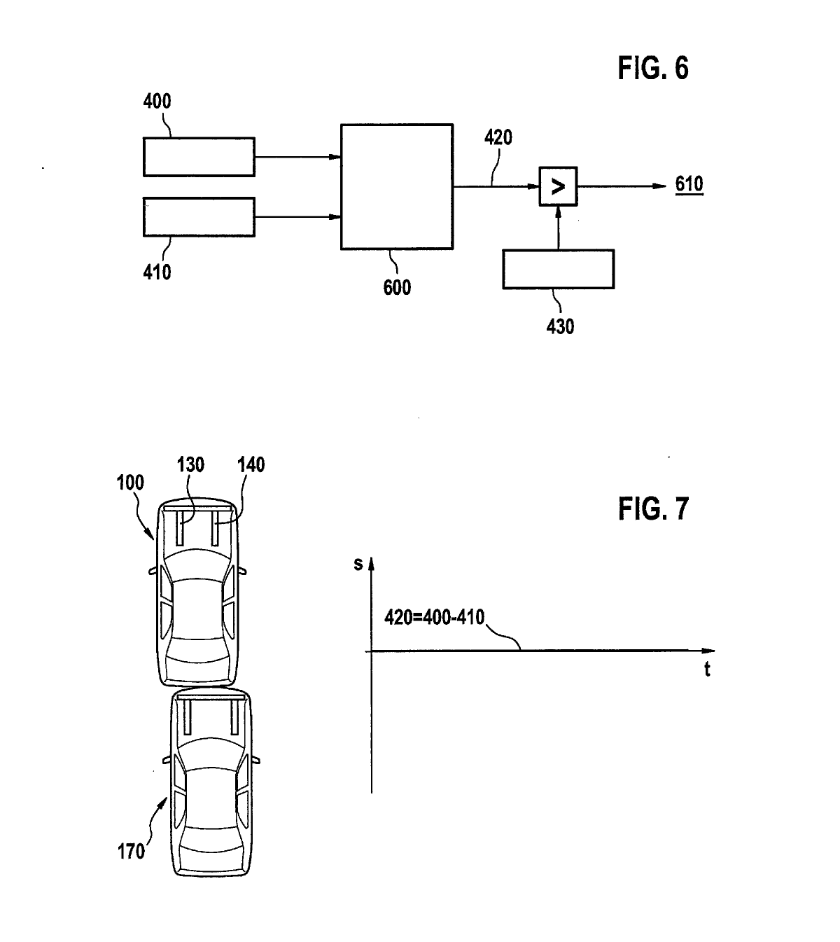

A first simple algorithm for offset detection with the aid of a simple threshold value query is shown in the block diagram of FIG. 6. In this diagram, a signal 400 of sensor 150 of left deformation element 130 (also denoted as the left channel) and a signal 410 of sensor 155 of right deformation element 140 of the adaptive deformation element structure are provided to a functional block 600. As indicated above, the function may represent every mathematical operation, and for the exemplary embodiment described here, a difference formation 420 is used. The formation of a ratio is also possible. The result is compared to a threshold value 430, which is developed as a parameter, and is able to be provided from a memory. Other, more demanding functions, such as storing and/or filtering as well as the summation of the logical states located above threshold value 430, and the subsequent query with respect to further threshold values are also possible. The result, in this example, is the detection of an offset collision 610 in response to the exceeding of a value of difference signal 420 of a threshold value 430.

In a rear-end collision, which is shown schematically in FIG. 7, no intrusions or deformations come about of adaptive structures 130 or 140. In a rear-end collision, in this context, the left and the right structures are not intruded, and therefore no signal change is recorded which represents the change in distance apart of the components of these deformation elements. In this way, deformation element structure 130, 140 is able to be used for a plausibility check of a rear-end collision onto vehicle 100, that is being observed. This information may be evaluated in connection with a central acceleration signal aₓ. Central acceleration signal aₓ, for instance, shows a positive acceleration, and variables derived from it thus characterize a rear-end collision. In comparison to this, no intrusions come about or signals from frontal structures 130 and 140. With that, a plausibility check for a rear-end collision may be constructed, which actuates the correspondingly suitable a restraint arrangement for a rear-end collision.

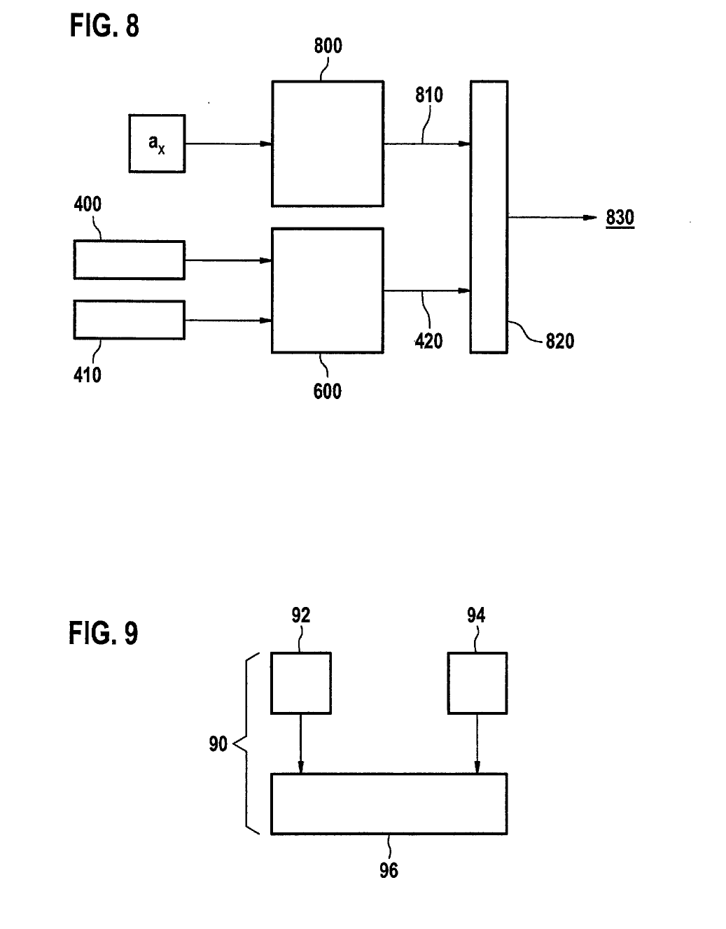

A first simple algorithm for detecting such a rear-end collision is shown as a block diagram in FIG. 8. In this diagram, an acceleration signal aₓ from a central acceleration sensor, for example, is processed in a rear-end crash algorithm 800, the output taking place as triggering signal 810. In parallel to this, the two channels 400 and 410 of adaptive structures 130 and 140 are processed in a further step, for instance while using a difference formation in a function block 600. Other functions are conceivable as well. The resulting signal 420 is combined with signal 810 from rear-end crash algorithm 800 in a plausibility check block 820. The plausibility check, in this context, may represent a simple Boolean operation, such as an AND operation, or other more demanding functions. Subsequently to this, there follows an actuation 830 of a restraint arrangement for rear-end collisions, e.g., an active head rest or systems integrated into the seat.

The detection of a “low overlap” collision is able to take place analogously to the offset detection. In this context, it is to be expected that the difference signals turn out appropriately smaller.

The severity of crash detection may furthermore take place via an additional evaluation with respect to the intrusion amplitude of the system and to the associated deformation speed. In this context, it is checked how quickly and to what extent the intrusion is taking place. Correspondingly, crash severity categories may be assigned, via the characteristic lines, which are used in the further course of the algorithm in order to make a triggering decision of the restraint components.

In a further step, beyond the pure separation into the cases

A) full frontal collision

B) 40% offset collision

C) low overlap collision

an estimation may also be made as to the degree of the overlap. The basis of such an estimation is in the measurement of the compatibility of the corresponding carrier structures of the two vehicles. Depending on whether these, in case A) full frontal, meet congruently (2×2 carrier structures) or in case B) 40% offset (1×1 carrier structures), the carrier chain, and with that the mass “supported” by the respective carrier structures is imaged in the acceleration signals. In case C), the carrier structures hardly meet any more, and this becomes correspondingly visible additionally via the deformation measurement and the deformation speed measurement of the measurement sensor system integrated into the structure. The basic characteristics of the deformation measurement and the deformation speed measurement of the integrated adaptive system, in combination with the measurement from the central acceleration sensor system may be drawn upon to determine the degree of offset, in a generalized form of the introduced present invention.

Other functions are implemented correspondingly. Over and above that, there naturally exists the possibility of combining these signals with other signals, such as from a driving dynamics control system, in order to image a new function, derived from this, which is in the field of passive safety. It is possible, for example, that, depending on the rotation of the vehicle and the corresponding intrusion (left or right), reversible components in the vehicle, such as seat components, might be actuated.

FIG. 9 shows a flow chart of an exemplary embodiment of the present invention as method 90, for detecting a width of an impact area of an object in the front-end section of a vehicle. The method includes a step of receiving 92 a first deformation element signal which represents a change in the distance of components from one another, of a first deformation element, that is mounted in the left front-end section of the vehicle. Furthermore, the method includes a step of receiving 94 a second deformation element signal which represents a change in the distance of components from one another, of a second deformation element, that is mounted in the left front-end section of the vehicle. Finally, the method has a step of detecting 96 an offset collision, with a small width of an impact area of the object on the vehicle, if the first deformation element signal differs by more than a predefined threshold value level from the second deformation element signal.

1-11. (canceled)

12. A method for detecting a width of an impact area of an object in a front-end section of a vehicle, comprising:
receiving a first deformation element signal which represents a change in a distance of components of a first deformation element from one another, that is mounted in a left front-end section of the vehicle;
receiving a second deformation element signal which represents a change in a distance of components of a second deformation element from one another, that is mounted in a right front-end section of the vehicle; and
detecting an offset collision with a small width of an impact area of the object, on the vehicle if the first deformation element signal differs by more than a predefined threshold value level from the second deformation element signal.

13. The method as recited in claim 12, wherein the detecting step includes linking the first deformation element signal to the second deformation element signal to obtain a linkage signal, the offset collision having the low width of the impact area being detected if an absolute signal level value of the linkage signal has a value that is greater than a predetermined threshold value.

14. The method as recited in claim 13, wherein in the detecting step, formation of at least one of a difference, an addition, a multiplication, and a division of values of the first and the second deformation element signals is carried out.

15. The method as recited in claim 13, wherein in the detecting step, an average width of an impact area of the object on the vehicle is detected if the first deformation element signal differs by more than a predefined second threshold value level but by less than the threshold value level of the second deformation element signal, or if an absolute value of the linkage signal has a value which is below the predetermined threshold value but above a predetermined second threshold value.

16. The method as recited in claim 13, wherein in the detecting step a large width of an impact area of the object on the vehicle is detected if the linkage signal has a signal level value which lies within a tolerance range about a value zero or if a value of the first deformation element signal does not differ within a tolerance range from the second deformation element signal.

17. The method as recited in claim 13, wherein in the detecting step, a rear-end impact of an object on the vehicle may be recognized if an additional signal, which represents a positive acceleration in a travel direction of the vehicle, is received together with a linkage signal, whose signal level value lies within a tolerance range about the value zero.

18. The method as recited in claim 13, further comprising:
outputting a control signal for a vehicle passenger protective unit of the vehicle in response to an evaluated linkage signal.

19. The method as recited in claim 12, wherein in the detecting step, a predetermined degree of severity of an impact of the object on the vehicle is further detected if a signal amplitude of at least one of the first and the second deformation element signal, changes within a predefined evaluation time by more than a predetermined difference in amplitude.

20. The method as recited in claim 12, wherein in the detecting step, responsive to a signal amplitude of at least one of the first and the second deformation element signal, a penetration depth is detected of the object into the vehicle.

21. A control unit that is configured to receive a first deformation element signal which represents a change in a distance of components of a first deformation element from one another, that is mounted in a left front-end section of the vehicle, receive a second deformation element signal which represents a change in a distance of components of a second deformation element from one another, that is mounted in a right front-end section of the vehicle, and detect an offset collision with a small width of an impact area of the object, on the vehicle if the first deformation element signal differs by more than a predefined threshold value level from the second deformation element signal.

22. A machine-readable medium storing program code, the program code, when executed on a control unit, causing the control unit to perform the steps of:
receiving a first deformation element signal which represents a change in a distance of components of a first deformation element from one another, that is mounted in a left front-end section of the vehicle;
receiving a second deformation element signal which represents a change in a distance of components of a second deformation element from one another, that is mounted in a right front-end section of the vehicle; and
detecting an offset collision with a small width of an impact area of the object, on the vehicle if the first deformation element signal differs by more than a predefined threshold value level from the second deformation element signal.
